(19) United States
(12) Patent Application Publication
(10) Pub. No.: US 2020/0110361 A1
(43) Pub. Date: Apr. 9, 2020

(54) HOLOGRAPHIC DISPLAY SYSTEM

(71) Applicant: Microsoft Technology Licensing, LLC, Redmond, WA (US)

(72) Inventors: Andreas GEORGIOU, Cambridge (GB); Joel Steven KOLLIN, Seattle, WA (US); Bernard Charles KRESS, Redwood City, CA (US); Jia JIA, Cambridge (GB); Adrian Robert Leigh TRAVIS, Paris (FR)

(73) Assignee: Microsoft Technology Licensing, LLC, Redmond, WA (US)

(21) Appl. No.: 16/155,741

(22) Filed: Oct. 9, 2018

(51) Int. Cl. G03H 1/02; G03H 1/04; G02B 27/09; G06F 3/01

(52) U.S. Cl. CPC G03H 1/0248; G03H 1/0402; G03H 2001/0439; G06F 3/013; G02B 27/0944

(57) ABSTRACT

A holographic display system includes a holographic optical element (HOE), which includes a first volume hologram configured to outcouple light to form a first exit pupil upon satisfaction of a first angular condition, and a second volume hologram configured to outcouple light to form a second exit pupil upon satisfaction of a second angular condition. A light source is configured to introduce light into the HOE at any of a range of angles. A light source controller sets a current angle of the light to a first angle that meets the first angular condition, forming the first exit pupil. The light source controller moves the first exit pupil by changing the current angle to a second angle that meets the first angular condition. The light source controller redirects light to form the second exit pupil by setting the current angle to a third angle that meets the second angular condition.

### BACKGROUND

Near-eye display devices (NEDs) can be used to provide augmented reality (AR) experiences and/or virtual reality (VR) experiences by presenting virtual imagery to a user eye. Virtual imagery can take the form of one or more virtual objects that are displayed such that they appear as if they are physical objects in the real world.

### BRIEF DESCRIPTION OF THE DRAWINGS

FIG. 1 schematically shows an example head-mounted display device including a near-eye display (NED).

FIGS. 2A and 2B schematically show an example holographic display system that may be implemented in the NED of FIG. 1.

FIGS. 3A and 3B schematically illustrate formation of an exit pupil by a holographic display system.

FIGS. 4A-4C schematically illustrate movement of an exit pupil based on input angle of light into the holographic display system.

FIGS. 5A and 5B schematically illustrate redirection of light to form a second exit pupil.

FIGS. 6A and 6B schematically illustrate how multiple volume holograms can each form an exit pupil at different positions.

FIG. 7 illustrates an example user eyebox with multiple moveable exit pupil positions.

FIG. 8 illustrates another example user eyebox with multiple moveable exit pupils arrayed in a triangular grid.

FIG. 9 illustrates an example method for a holographic display system.

FIG. 10 schematically illustrates an example computing system.

### DETAILED DESCRIPTION

As described above, a head-mounted display device (HMD) may include a near-eye display (NED) to provide immersive imagery to wearers. An HMD may combine virtual imagery generated by a NED with a view of the surrounding physical environment in a “mixed” or “augmented” reality configuration, or may replace at least a portion of a wearer's field of view with NED output in a “virtual reality” configuration. The NED may assume various configurations that enable its output of virtual imagery.

In some examples, the NED may incorporate holographic optics for directing display light toward a user eye. Such holographic optics, for example implemented in a holographic optical element (HOE), may enable inbound light meeting certain angular conditions (e.g., a Bragg condition) to be focused/redirected toward a corresponding exit pupil of the display system (not to be confused with a human eye pupil, which is the anatomical feature through which light enters the eye). Depending on the types of holographic optics used, various degrees of angular selectivity may be achieved, which has ramifications for the size of the eyebox that can be produced. As used herein, an “eyebox” refers to a two-dimensional plane in which a human eye pupil can receive image light from the HOE. In practical implementations the eyebox need not be a plane or rectangle, though it will be described herein as such for the sake of simplicity. Expanding the size of the eyebox is a common design goal for holographic NEDs, especially when a large field-of-view (FOV) is desired.

Some holographic elements, sometimes referred to as “thick” holograms or volume holograms, have relatively high angular selectivity, meaning only input light meeting a relatively narrow range of angles will activate the hologram. The output angle of light θₒᵤₜ diffracted by a volume hologram may be related to the angle θᵢₙ of light incident on the HOE by a functional relation of the following form: θₒᵤₜ=F(θᵢₙ). This means that a given hologram may redirect light having a specified input angle (or narrow range of input angles) to an almost arbitrary output angle, allowing for flexibility in the design of the holographic display system. However, the high angular selectivity of volume holograms can limit the size of the eyebox that can be produced by any single volume hologram, as even small variations of inbound light from the recording angle of the hologram can result in formation of an image with undesirable aberrations, or fail to activate the hologram entirely.

Accordingly, the present disclosure is directed to a holographic display system that makes use of multiple volume holograms to display virtual imagery in a relatively large eyebox. One example display system includes a light source configured to introduce light into a HOE at any angle in a range of input angles. The HOE includes two or more volume holograms, each configured to outcouple light toward a respective exit pupil when an angular condition of the volume hologram is satisfied. Thus, by varying the input angle of light introduced into the HOE, an exit pupil may be formed at any of two or more positions, effectively expanding the eyebox. Furthermore, the angular condition of each volume hologram may be satisfied by any of a range of input angles, and varying the input angle may cause the volume hologram to form its exit pupil at a different position. Thus, the position of any particular exit pupil may be “steered” by changing the input angle of the light incident on the volume hologram to a different angle that still meets the hologram's angular condition. The holographic display system described herein therefore allows light to be focused at any of a plurality of potential exit pupil positions, allowing imagery to be viewed in a relatively large eyebox while reducing visible aberrations. In some cases, as described below, pupil steering may be achieved via Bragg degeneracy, whereby input and output angles to a volume hologram fall outside the recorded plane of the hologram.

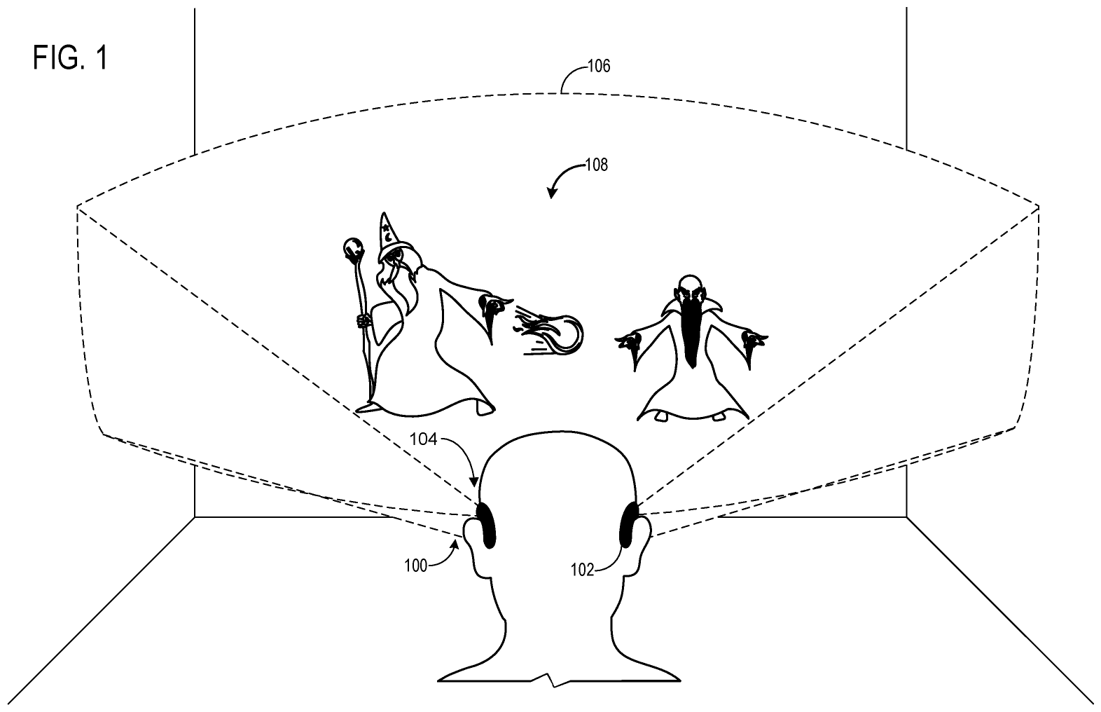

FIG. 1 shows an example HMD device 100 in the form of a pair of wearable glasses 102 including a NED 104. NED 104 is configured as a virtual reality display with which substantially the entirety of the surrounding physical environment is occluded, and which allows at least a portion of a user's field of view 106 to be replaced with virtual imagery presented by the NED. As an example, FIG. 1 shows virtual imagery 108 presented by NED 104 in field of view 106.

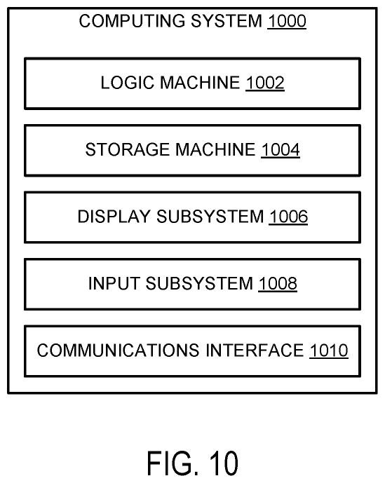

HMD device 100 includes a controller (not shown in FIG. 1) for controlling NED 104. Among other potential operations, the controller may drive NED 104 to control the display of virtual imagery. The controller may include a logic device and/or a storage device, examples of which are described below with reference to FIG. 10. In some examples, the controller may communicate with one or more devices remote from the HMD device.

The controller may interface with one or more sensors provided within or remotely from HMD device 100. The sensor(s) may include, but are not limited to, a microphone array, one or more outward facing image sensors, one or more inward facing image sensors (e.g., an eye/gaze tracking system), and an inertial measurement unit (IMU). As one example, the controller may use output from the IMU to adjust output from NED 104 that reflects movement of the wearer so that the wearer feels present in the virtual environment displayed on the NED. As another example, the controller may cause display of a view of the surrounding physical environment on NED 104 captured via outward facing image sensors in a stereo arrangement, which may enable generating imagery at different perceived depths. In this example, NED 104 may present a mixed reality environment in which virtual imagery is superimposed over the captured view of the physical environment.

The example display systems described herein also may be implemented in devices other than HMD device 100. Examples of such devices may include other HMD devices, other wearable devices, mobile non-wearable devices, and stationary devices.

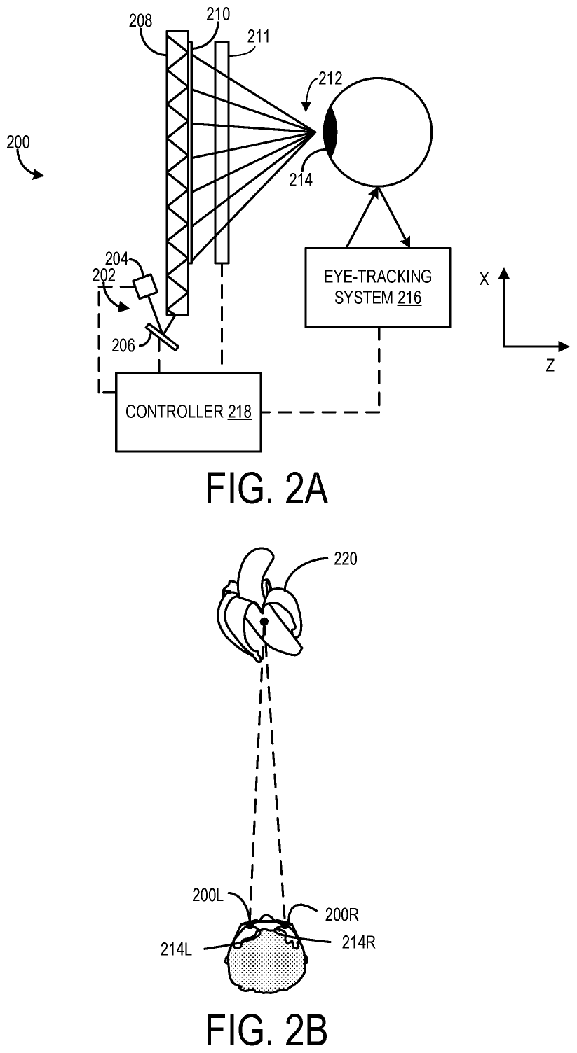

FIG. 2A shows an example display system 200 that may be implemented in NED 104. Display system 200 is operable to position an exit pupil and provide an eyebox in which virtual imagery generated by the display system is viewable. Display system 200 may correspond to a single eye and may in some cases be paired within a NED and/or HMD with a second, similar display system for displaying imagery to a second eye. It will be understood that FIG. 2A shows the example display system 200 schematically, and is not drawn to scale. FIGS. 2B, 3A, 4A, and 5A-6A are similarly schematic in nature.

Display system 200 includes a light source 202 configured to output light at any of a range of angles. Light source 202 includes a microprojector 204 and a steerable micromirror 206. Light source 202 may output collimated light, which in some examples may be spatially modulated to create an image. In addition to or as an alternative to microprojector 204, light source 202 may include any suitable optics for outputting light for creating and projecting images. The light source 202 further may include image-producing optics, such as a spatial light modulator for creating an image. The term “light source” is used herein as any suitable optics for outputting light to the other depicted components in the image, whether the light does or does not encode an image.

In the depicted example, output from light source 202 is introduced into waveguide 208. The input angle at which light is introduced into waveguide 208 may be controllable in various manners. As one example, FIG. 2A shows a steerable micromirror 206 controllable to change the angle at which light from microprojector 204 is introduced into waveguide 208 to steer an exit pupil of the display system 200. In other examples, different light sources arranged at different angles may be used to vary an input angle by selecting which light to use for illumination, or any other suitable method of varying a light input angle may be used. While not depicted in FIGS. 2A, an in-coupling element may be provided to facilitate in-coupling of light into waveguide 208.

Once within the waveguide, light may propagate via total internal reflection before reaching a HOE 210. The angle at which the light propagates within the waveguide, and therefore the angle of the light incident upon the HOE, depends on the angle at which light enters the waveguide. Thus, light source 202 may introduce light into the HOE at any of a range of input angles by varying the angle at which the light enters the waveguide. Furthermore, while FIG. 2A shows waveguide 208 disposed between the light source and HOE, other arrangements are within the scope of this disclosure. For example, in some implementations, waveguide 208 may be moved, replaced, or omitted entirely, provided light from light source 202 is suitably directed into HOE 210.

HOE 210 outcouples light received from within the waveguide that meets an angular condition of the HOE. HOE 210 may include, for example, at least one volume hologram configured to outcouple light to form an exit pupil when an angular condition of the volume hologram is satisfied. FIG. 2A shows, for a given light input angle, light outcoupled by the HOE 210 converging toward an exit pupil 212. HOE 210 may encode optical power to focus the outcoupled light, and/or a different component may be used to encode optical power.

As discussed above, light source 202 may in some cases may include image-producing optics, such as a spatial light modulator, for forming an image. Additionally, or alternatively, display system 200 may include a dynamic digital hologram (DDH) 211 disposed between HOE 210 and user eye 212. DDH 211 may be configured to form at least a portion of the virtual imagery that is presented to the user eye. For example, the DDH may be logically partitioned into a plurality of digital holograms that each form part of an image using light from HOE 210. The plurality of digital holograms may be formed by partitioning a single image producing panel and/or by providing multiple separate image producing panels. The DDH may be configured to produce imagery via first order diffracted light, and/or through the use of other orders of diffracted light. In FIG. 2A, DDH 211 is a transmissive element. In alternate implementations, however, DDH 211 may be reflective, in which case it may be disposed on the opposite side of waveguide 208.

As discussed above, volume holograms typically have some degree of angular selectivity. This means they will only refract light having an input angle that falls within a relatively narrow range, thereby satisfying the angular condition of the volume hologram. Volume holograms are typically constructed by directing two beams of light into the recording medium such that they interfere in a controlled manner. These two recording beams form a recording plane for the volume hologram. In some examples, the recording beams may be two diverging beams. The angle of the two beams may vary at each point on the volume hologram. For the sake of simplicity, however, this description will focus on a single point on the surface of the volume hologram, although it will be understood that the same principles will apply to any point on the surface of the volume hologram.

Maximum diffraction efficiency for the volume hologram is achieved for light having an input angle that matches a recording input angle of the volume hologram, which lies in the recording plane. Within the recording plane, the volume hologram is highly angle-specific, and minor deviations from the recording input angle will fail to activate the volume hologram. As will be discussed in more detail below, however, the angular condition may be satisfied by a range of input angles that do not lie within the recording plane. In other words, input angles of light that do not match the recording input angle or fall within the recording plane of the volume hologram may nonetheless activate the volume hologram and cause formation of an exit pupil. This phenomenon is known as Bragg degeneracy.

For the light input angle illustrated in FIG. 2A, the outcoupled, diffracted rays converging toward exit pupil 212 are proximate a human eye pupil 214. Light outcoupled by HOE 210 may therefore enter the eye via human eye pupil 214 and strike the retina, causing the light to be perceived as an image. Though FIG. 2A depicts the light focusing at a point outside of the human eye pupil, this is for illustration purposes only. In practical use, the light may converge toward a focal point that lies before, within, or beyond the human eye. In some examples, the exit pupil formed by the volume hologram may coincide with the human eye pupil. Light entering the human eye pupil may be focused by the eye lens to modify the light's focal point, for example to focus the light at the retina.

As discussed above with respect to FIG. 1, light striking the eye retina may be perceived by the wearer as an image, such as virtual imagery 108. When light is stereoscopically projected toward both wearer eye retinas at once, the virtual imagery may be perceived as a three-dimensional object that appears to exist at a three-dimensional position within the wearer's environment.

This is shown in FIG. 2B, which shows an overhead view of a wearer using a NED. As shown, the NED includes two holographic display systems including a first display system 200L, positioned in front of the wearer's left eye pupil 214L, and a second display system 200R positioned in front of right eye pupil 214R. It will be understood that holographic display system 200 shown in FIG. 2A may be either of display systems 200L and 200R. Similarly, human eye pupil 214 shown in FIG. 2A may be either of pupil 214L and 214R shown in FIG. 2B. A virtual image 220 is visible to the wearer as a virtual object present at a three-dimensional position some distance away from the wearer. As discussed above, such an image may be formed via light outcoupled by HOEs of display systems 200L and 200R entering human eye pupils 214L and 214R.

Returning to FIG. 2A, in some examples, display system 200 may vary the exit pupil location based on the location of the user eye pupil. Thus, FIG. 2A shows an eye-tracking system 216 configured to track a current position of the human eye pupil. In some examples, eye-tracking system 216 may include a light source that projects light onto the eye, and an image sensor that captures light reflected from the cornea with which glints and/or other features can be identified to determine the pupil location. The pupil location identified by eye-tracking system 216 may be provided to a light source controller 218, which may be configured to set a current angle of the steerable micromirror to set the current input angle of light into waveguide 208. In some examples, the light source controller may be configured to set the current input angle of the light to cause formation of an exit pupil proximate to the current position of the human eye pupil. Controller 218 may be configured to control image formation by DDH 211, when included. Controller 218 may be implemented as any suitable processing componentry, including logic machine 1002 described below with respect to FIG. 10.

It will be understood that the components and arrangements shown in FIG. 2A are presented for the sake of example and are not limiting. In some examples, waveguide 208 may have a geometry other than the flat, rectangular shape shown in FIG. 2A. For example, the waveguide may have the shape of a wedge or a curved wedge. Moreover, the focusing of light outcoupled from waveguide 208 provided by optical power encoded in HOE 210 may instead be provided by a lens. The encoded optical power may also increase the field of view in a generated eyebox, though with a reduction in the size of an exit pupil. By variably positioning the exit pupil, however, the correspondence between exit pupil position and user eye pupil position may be maintained.

The light from light source 202 may be substantially monochromatic or multi-color (e.g., red, green, blue). In some examples that utilize multi-color light, light source 202 may perform color field-sequential display. For implementations in which aberration correction components are used to correct for any aberrations in the exit pupil (e.g., caused by steering of the exit pupil), such components may be independently controlled for each color channel to provide aberration correction suited for each color channel. One example of such corrective components may include a phase modulating display panel, such as a transmissive liquid crystal panel or a reflective liquid crystal on silicon (LCOS) display. Other corrective elements may include a liquid crystal (LC) lens, a micromirror array, and a deformable mirror, as examples.

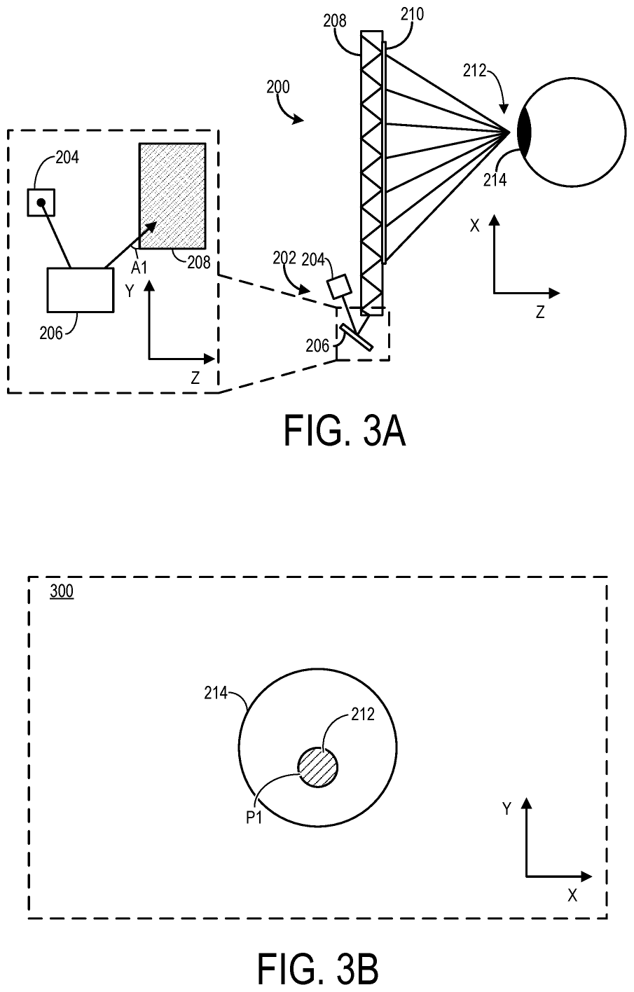

FIG. 3A again shows holographic display system 200. In FIG. 3A, as well as the subsequent figures in which display system 200 appears, DDH 211, eye tracking system 216, and controller 218 are omitted. This is done only for the sake of visual clarity. As discussed above, the dynamic digital hologram, eye tracking system, light source controller, and other components shown in FIG. 2A may be included, omitted, and/or modified depending on the implementation.

FIG. 3A includes an alternate view of microprojector 204, steerable micromirror 208, and waveguide 208, in which such components are viewed “side-on,” in contrast to the “top-down” view shown in FIG. 2A and the remainder of FIG. 3A. The side view of waveguide 208 more clearly shows light entering the waveguide at a first input angle A1. Notably, the angle of light entering the waveguide may be varied relative to multiple spatial dimensions, for instance to achieve input angles of light that do not fall within the recording plane of the volume hologram, and yet activate the volume hologram via Bragg degeneracy. In other words, when light enters the waveguide at an angle that is normal to the face of the waveguide, the light may be parallel to the X axis. Steering of the steerable micromirror may cause this input angle to pivot about the Y axis and/or pivot about the Z axis. Steering of the micromirror may also cause the light to enter the waveguide at a different two-dimensional position relative to the face of the waveguide. However, this should not affect propagation of the light within the waveguide provided that the waveguide has substantially uniform in-coupling properties along its face.

FIG. 3B shows an example user eyebox 300. As discussed above, the user eyebox may be defined by a two-dimensional plane, in this case the XY plane, in which the human eye pupil can receive light outcoupled by the HOE. Eyebox 300 is depicted as being rectangular in shape, though this is not limiting. In some examples, a user eyebox may be rounded or ellipsoid to match or approximate the range of motion of the human eye pupil, although any suitable shape may be used. Furthermore, the eyebox need not be a strict two-dimensional plane, and may in some cases be a region of three-dimensional space.

FIG. 3B shows the position of human eye pupil 214 within eyebox 300. FIG. 3B also shows exit pupil 212 at a first position P1, which corresponds to the first input angle A1 of the light emitted by light source 202. In other words, in FIG. 3A and 3B, the light source controller has controlled the light source to set a current input angle of the light to the waveguide to a first input angle A1. This light ultimately reaches the HOE at an angle that satisfies the angular condition of the volume hologram and causes formation of the first exit pupil. As will be described in more detail below, however, other input angles may also satisfy the angular condition of the volume hologram and cause the exit pupil to form at a different position. Thus, the exit pupil may be moved within the eyebox, for instance to follow the human eye pupil.

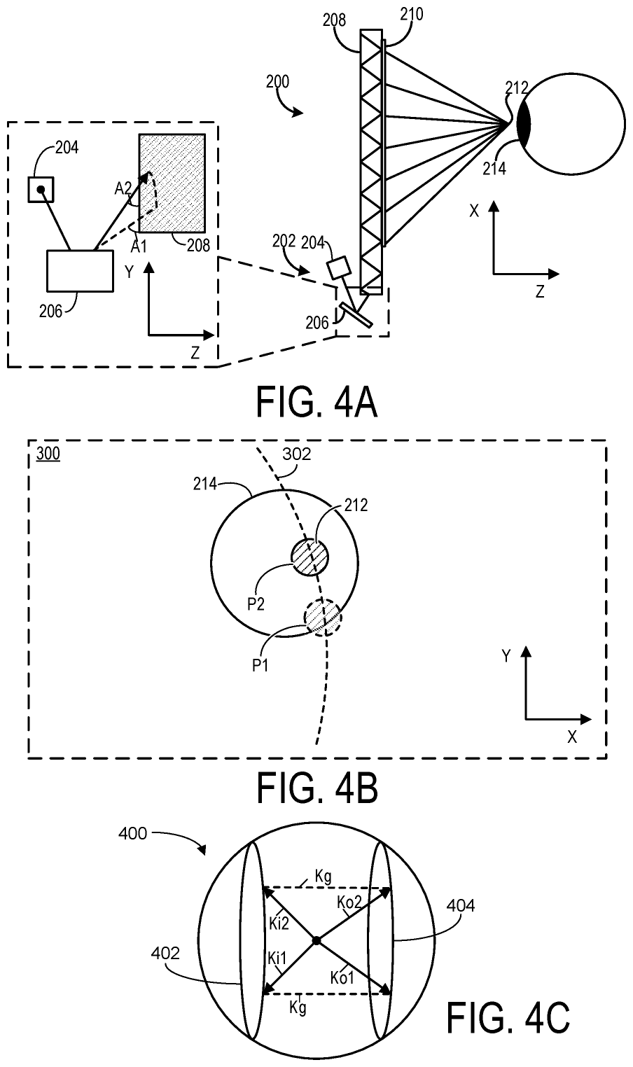

This is described with respect to FIG. 4A, which again shows holographic display system 200, and again includes the side view of waveguide 208 introduced in FIG. 3A. In FIG. 4A, the angle of light entering waveguide 208 has been changed from the first input angle A1 to a second input angle A2. Relative to angle A1, second input angle A2 has pivoted about the Z axis, causing the light to enter the waveguide at a greater angle relative to the X axis. As discussed above, though the light is depicted as entering waveguide 208 at a different two-dimensional position relative to the face of the waveguide, this should not affect propagation of light within the waveguide. Furthermore, in alternate implementations the light may always be introduced into the waveguide at the same two-dimensional position, with only the input angle changing.

After entering waveguide 208 at the second input angle A2, the light may propagate via total internal reflection before reaching HOE 210 at an angle that still satisfies the angular condition of the volume hologram. However, changing the light input angle causes a corresponding change to the output angle of light exiting the HOE, which in turn causes formation of the exit pupil at a different position within the eyebox.

This is illustrated in FIG. 4B, which again shows eyebox 300. However, in FIG. 4B, exit pupil 212 is shown at a second position P2. First position P1 is still shown for reference, though it will be understood that the exit pupil no longer forms at position P1. In this example, the exit pupil has been moved to follow human eye pupil 214, which is also shown at a different position relative to FIG. 3B.

In FIG. 4B, the first position P1 and the second position P2 are both arrayed along a curved line 302. Curved line 302 defines a range of possible positions for exit pupil 212 corresponding to input angles of light that satisfy the angular condition of the volume hologram. In general, as discussed above, volume holograms are recorded by controlled interference of two beams of light incident on the recording medium. The resulting volume hologram will have a recording plane defined by the two beams of light, with a recording input angle lying within the plane that can be said to represent an ideal input angle of light to the volume hologram. It will be understood that the term “ideal input angle” does not necessarily indicate an improved performance over other possible input angles, and rather merely indicates that the current input angle matches the recording angle of the volume hologram. In other words, light incident on the volume hologram at the recording input angle will cause output of light with maximum diffraction efficiency. With regard to HOE 210, the volume hologram is configured to form the exit pupil at an ideal position of the exit pupil when the current input angle of light matches the recording input angle of the volume hologram.

However, as discussed above, the volume hologram may be activated by a range of input angles that do not lie within the recording plane of the volume hologram, and yet still satisfy the angular condition (e.g., Bragg condition) of the volume hologram. Specifically, the Bragg condition of the volume hologram may be met by a range of input angles that define a circle positioned on the surface of a sphere, where the inbound input light originates from the center of the sphere. Each input angle that satisfies the Bragg condition for the hologram is matched by a corresponding output angle, where the range of possible output angles define a second circle on the surface of the same sphere. The two circles corresponding to the condition-satisfying input angles and their corresponding output angles are separated by a fixed distance, corresponding to the grating vector for the volume hologram. Notably, the input angles may not lie within a recording plane of the volume hologram, and yet still cause activation of the hologram. This phenomenon is referred to as Bragg degeneracy. In other words, the angular condition of the volume hologram may be satisfied by the recording input angle and a range of angles that satisfy the Bragg condition of the volume hologram via Bragg degeneracy.

FIG. 4C illustrates the sphere described above, sometimes referred to as a k-sphere. As shown, sphere 400 includes an input circle 402 defining input angles that satisfy the Bragg condition for the first volume hologram, and an output circle 404 that defines corresponding output angles. It will be understood that input circle 402 includes input angles that do not fall within a recording plane of the volume hologram. A first input angle Ki1 is shown extending from the center of the sphere to input circle 402. First input angle Ki1 is matched by a corresponding output angle Ko1, which is offset from input angle Ki1 by a fixed distance Kg corresponding to the grating vector of the volume hologram. FIG. 4C also shows a second input angle Ki2 extending to the edge of input circle 402. Second input angle Ki2 is matched by a corresponding second output angle Ko2, also offset by the grating vector Kg.

Returning to FIG. 4B, as discussed above, curved line 302 defines the range of possible positions of the exit pupil that can be achieved by input angles of light that satisfy the angular condition of the volume hologram. Thus, curved line 302 is analogous to output circle 404 from FIG. 4C. If the input angle of light to the volume hologram is progressively changed to trace input circle 402 of FIG. 4C, the output angle will trace output circle 404, and the position at which exit pupil 212 forms will follow curved line 302. The light source controller may therefore change a position of the first exit pupil by controlling the light source to change the current input angle of the light from the first input angle (e.g., angle A1) to a second input angle (e.g., angle A2), provided the second input angle still satisfies the angular condition of the volume hologram.

Input angles of light that do not satisfy the angular condition of the volume hologram will typically not result in formation of the exit pupil. Furthermore, though an exit pupil may be formed by input angles of light that satisfy the angular condition, input angles that deviate significantly from the recording input angle of the volume hologram may result in formation of an exit pupil with undesirable aberrations. Such aberrations may include, for example, visible artifacts, a loss in clarity, or a reduction in brightness. It may therefore be beneficial to further expand the user eyebox by including more than one volume hologram in the HOE, each volume hologram having a different angular acceptance range and configured to form a different exit pupil.

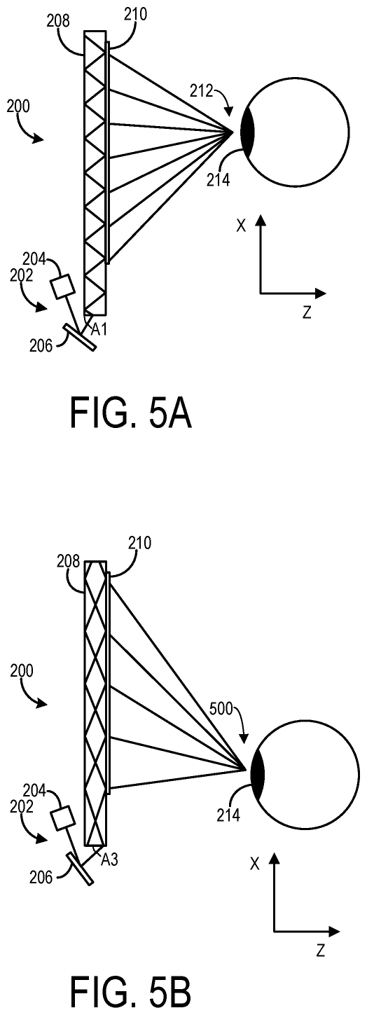

This is illustrated in FIGS. 5A and 5B, which again show holographic display system 200. In particular, FIG. 5A shows display system 200 in substantially the same state as it is depicted in FIG. 3A. Light source 202 is introducing light into waveguide 208 at a first input angle A1. HOE 210 outcouples the light toward exit pupil 212, which is proximate to human eye pupil 214. However, exit pupil 212 may be a first exit pupil that is associated with a first volume hologram of the HOE. In other words, HOE 210 may include a second volume hologram configured to outcouple light to form a second exit pupil upon satisfaction of a second angular condition of the second volume hologram. In general, the HOE may include any number (i.e., a plurality) of additional volume holograms, each configured to outcouple light to form respective exit pupils upon satisfaction of respective angular conditions.

This is illustrated in FIG. 5B, which shows formation of a second exit pupil 500 at a different position than first exit pupil 212. HOE 210 includes a second volume hologram configured to outcouple light to form second exit pupil 212 upon satisfaction of a second angular condition. In some cases, the first and second volume holograms may be angularly multiplexed in the HOE. The second exit pupil may be formed when the input angle of light to the waveguide is changed to a third input angle A3 that meets the angular condition of the second volume hologram. In other words, the light source controller may redirect light to form the second exit pupil by controlling the light source to introduce light at the third input angle. Specifically, as shown, the third input angle is pivoted about the Y axis relative to the first input angle A1, causing the light to enter the waveguide at a smaller angle relative to the face of the waveguide.

The first and second volume holograms may be constructed such that the first angular condition of the first volume hologram and the second angular condition of the second volume hologram do not intersect. In other words, there may be no possible input angles of light that activate both the first and second volume holograms at once. This may prevent formation of two exit pupils at once, which can cause a user to perceive doubled or offset images. By matching the angle of light incident on HOE 210 to an acceptance range for a desired hologram of the HOE, outcoupled light can be selectively switched between exit pupils in an aberration-free manner. As such, the light source controller may control the light input angle to achieve a hologram-specific incidence angle.

In other examples, however, the first and second volume holograms may be constructed such that their angular acceptance ranges overlap at least partially. Depending on the implementation, this overlap may only occur on some parts of the surface of the HOE. In such cases, to avoid formation of more than one exit pupil at once, the light source controller may be configured to avoid introducing light at an input angle that would activate more than one hologram at once. Alternatively, when the volume holograms are recorded such that only one exit pupil can fall within a human eye pupil at once, then the light source controller may deliberately cause formation of two or more exit pupils at the same time. This may, for example, expand the eyebox by allowing the user to see the virtual image from multiple possible eye pupil positions, albeit at the expense of brightness.

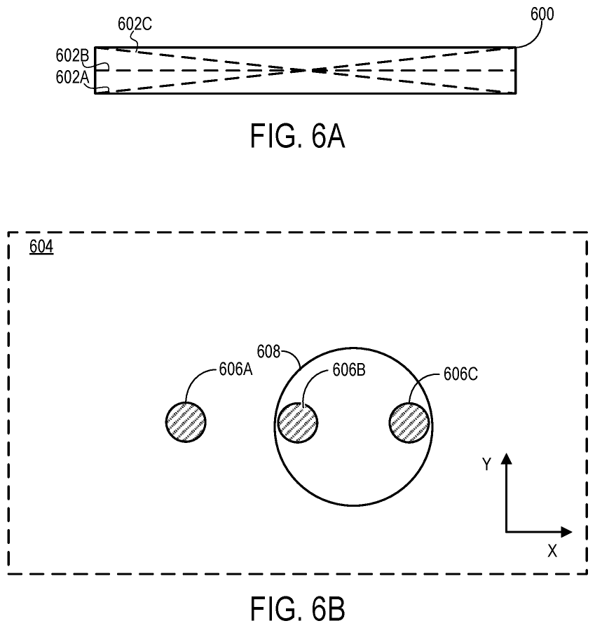

FIG. 6 shows a schematic representation of another example HOE 600 including three angularly multiplexed holograms 602A, 602B, and 602C. Each hologram 602A-C includes a respective angular acceptance range or bandwidth—e.g., the range of incidence angles at which the Bragg condition is met—and a respective exit pupil toward which the hologram diffracts light. The total range of light input angles and incidence angles sufficient to access each hologram 602 may be a function of the number of holograms in HOE 600 and the angular acceptance range for each hologram. As such, angular acceptance, hologram number, and total angular range sufficient to access each hologram may be balanced in HOE 600 to achieve desired optical performance. Further, HOE 600 may include multiple holograms designed for the same incidence angles but different wavelengths of light. For example, HOE 600 may include three holograms designed for the same incidence angles but configured to diffract light in red, green, and blue wavelength ranges, respectively.

FIG. 6B shows another example user eyebox 604, which includes three exit pupil positions 606A-606C. Each of the exit pupils 606 may correspond to a particular volume hologram 602 in HOE 600. It will be understood that each of exit pupils 606A-606C need not be formed at the same time. Rather, FIG. 6B shows the potential positions of exit pupils that could be formed via activation of the volume holograms 602.

Furthermore, the exit pupil positions 606 shown in FIG. 6B correspond to the ideal positions of the exit pupils. As discussed above, each volume hologram in the HOE may have a recording input angle that, when matched by incident light, causes formation of the volume hologram's exit pupil at an ideal position of the exit pupil. In other words, each of the plurality of volume holograms in the HOE is configured to outcouple light to form respective exit pupils at ideal positions of the respective exit pupils when respective angular conditions are satisfied.

The volume holograms in the HOE may in some cases be recorded to target a particular spacing between the ideal positions of the exit pupils. For example, as is shown in FIG. 6B, exit pupil positions 606B and 606C both fall within human eye pupil 608. The spacing between the ideal positions of the two exit pupils is therefore less than the human eye pupil diameter. This may be done such that, as the human eye pupil moves within the eyebox, there is always at least one potential exit pupil position that falls within the eye pupil. As the eye pupil moves away from exit pupil position 606B, exit pupil position 606C comes into view, allowing the light source controller to switch exit pupil formation to exit pupil 606C. Because the diameter of a typical human eye pupil will change depending on current lighting conditions, the spacing between adjacent exit pupil positions may be less than a preset distance, for example corresponding to an average human pupil diameter. In some examples, the preset distance may be equal to 2 mm, as this corresponds to a typical minimum eye pupil diameter under bright lighting.

As discussed above with respect to FIGS. 4A-4C, a volume hologram in a HOE may be activated by a range of potential input angles of light, and this can be used to steer exit pupil positions in the eyebox. This phenomenon may be exploited even when the HOE includes multiple volume holograms. In other words, the above description described how a first input angle of light may cause formation of a first exit pupil, and changing the input angle to a second input angle of light that satisfies an angular condition of a first volume hologram changes the position of the first exit pupil. The light source controller may activate a second volume hologram by introducing light at a third input angle that satisfies a second angular condition of the second volume hologram, thereby causing formation of a second exit pupil. This may, for example, correspond to an ideal position of the second exit pupil when the third input angle matches the recording input angle of the second volume hologram. Notably, however, the angular condition of the second volume hologram may be met by a range of angles that satisfy the Bragg condition of the second volume hologram via Bragg degeneracy. Thus, the light source controller may change a position of the second exit pupil by controlling the light source to set the current input angle of the light to a fourth input angle, provided the fourth input angle meets the second angular condition of the second volume hologram.

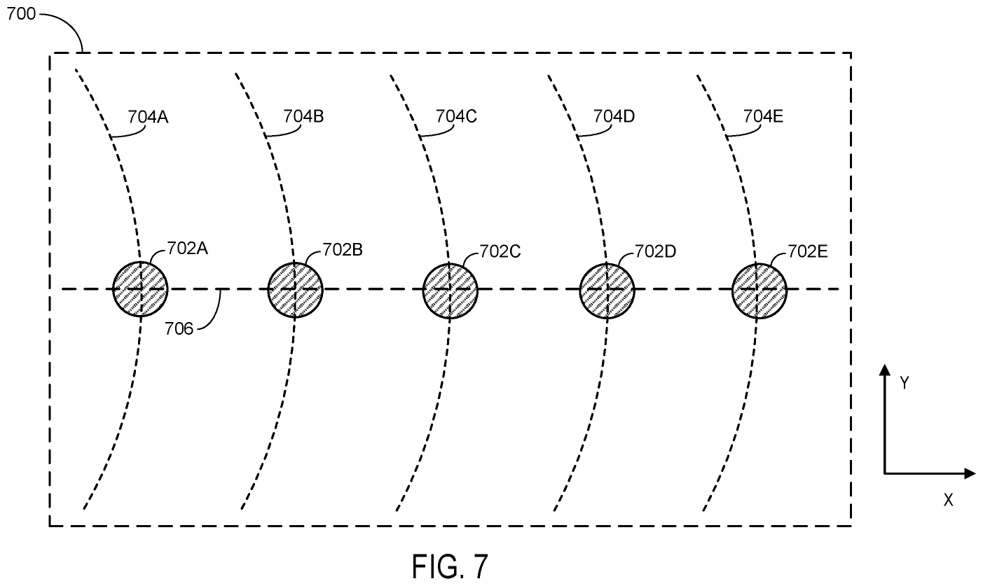

FIG. 7 shows another example eyebox 700 that has been expanded via use of multiple volume holograms in a HOE, which can be used to form an exit pupil at any of multiple potential positions. Specifically, eyebox 700 shows the ideal positions 702A-702E of each of the discrete exit pupils that can be formed by the volume holograms. FIG. 7 also shows, for each of the ideal eyebox positions, curved lines 704A-704E indicating the range of possible positions that exit pupil can be steered to by varying the input angle of light.

In the illustrated example, the ideal positions of each of the exit pupils are arrayed along a same plane, indicated by dashed line 706. Notably, this plane is perpendicular to the user eyebox plane. However, in alternate implementations, one or more of the exit pupil ideal positions may be arrayed on different planes each perpendicular to the user eyebox plane.

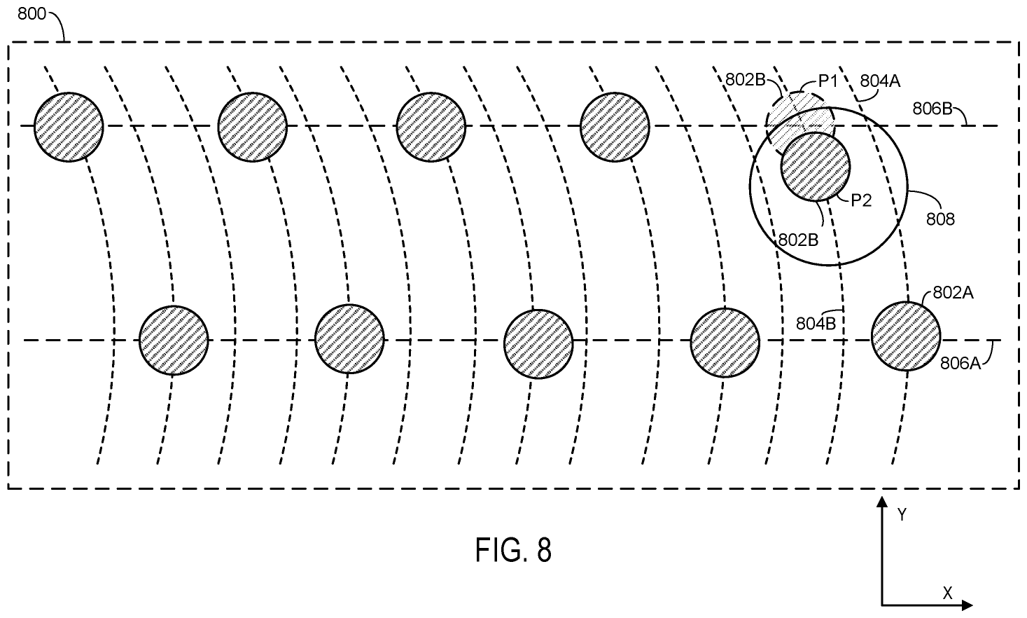

This is illustrated in FIG. 8, which shows another example eyebox 800. Eyebox 800 includes a plurality of potential exit pupil positions. Among others, a first exit pupil 802A is shown at an ideal position toward the bottom-right corner of the eyebox. A second exit pupil 802B is shown at two different positions P1 and P2. It will be understood that position P1 represents the ideal position of exit pupil 802B, although the exit pupil has been steered away from its ideal position to the second position P2. Exit pupils 802A and 802B are shown along with curved lines 804A and 804B representing the range of potential positions that each exit pupil can be steered to. Notably, exit pupil 802B has been steered along curved line 804B from position P1 to position P2.

The ideal position of exit pupil 802A, along with other idea exit pupil positions shown in FIG. 8, is arrayed along a first plane indicated by line 806A, which is perpendicular to the eyebox plane. Similarly, the ideal position of exit pupil 802B (shown at P1), along with the ideal positions of other exit pupils in the eyebox, is arrayed along a second plane indicated by line 806B, which is also perpendicular to the eyebox plane. In this arrangement, the ideal positions of the exit pupils are arrayed in the user eyebox plane as a triangular grid, although any suitable arrangement of ideal exit pupil positions may be used. This may serve to reduce the amount of steering required to move any particular exit pupil to the current position of the human eye pupil.

For example, in FIG. 8, exit pupil 802B has been steered away from its ideal position to fall within human eye pupil 808. Because position P2 is relatively close to ideal position P1, relatively minor steering is required to achieve the desired exit pupil movement. In contrast, if the human eye pupil was present at the same position in eyebox 700 of FIG. 7, relatively more steering would be required to bring an exit pupil within the eye pupil, which can result in more prominent aberrations. Thus, by distributing the ideal positions of the exit pupils along multiple planes throughout the eyebox, the amount of required steering can be reduced, thereby reducing aberrations attributable to steering of exit pupils.

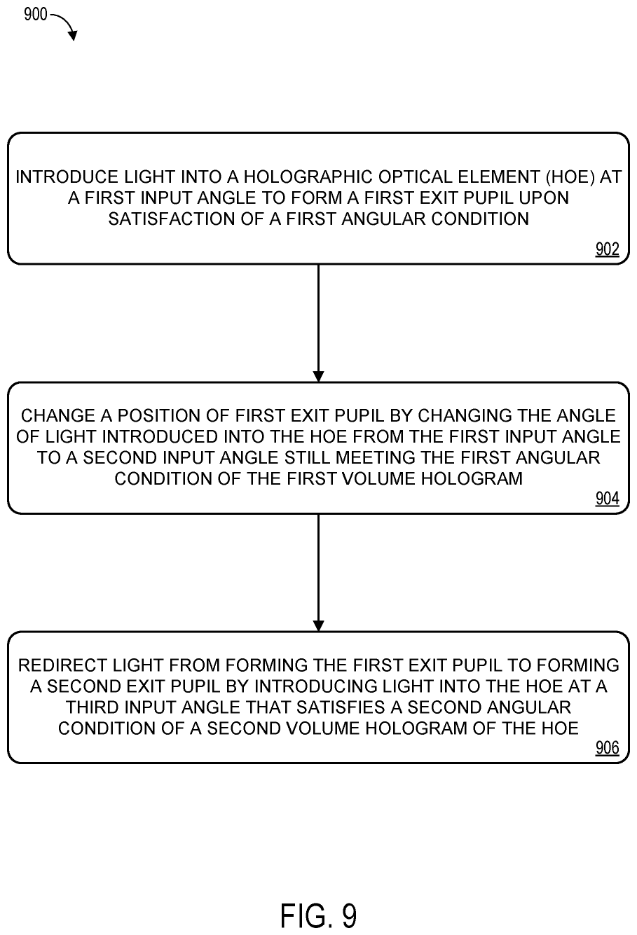

FIG. 9 illustrates an example method 900 for a holographic display system. Method 900 may be implemented using any suitable combination of hardware. For example, method 900 may be implemented with HMD 100 of FIG. 1, holographic display system 200, the example HOE 600 shown in FIG. 6A, the example computing system 1000 described below with respect to FIG. 10, etc.

At 902, method 900 includes introducing light into a HOE at a first input angle that satisfies a first angular condition of a first volume hologram of the HOE. As discussed above, in some scenarios the first input angle may be equal to a recording input angle of the volume hologram, causing formation of a first exit pupil at an ideal position of the first exit pupil.

At 904, method 900 includes changing a position of the first exit pupil by changing introduction of light into the HOE from the first input angle to a second input angle that still meets the first angular condition of the first volume hologram. For example, the angular condition of the first volume hologram may be satisfied by a recording input angle of the first volume hologram and a range of angles that satisfy the Bragg condition via Bragg degeneracy. Thus, by changing the input angle of light to the volume hologram, the position at which the first exit pupil is formed may be steered throughout the eyebox.

At 906, method 900 includes redirecting light from forming the first exit pupil to forming a second exit pupil by introducing light into the HOE at a third input angle that satisfies a second angular condition of a second volume hologram. Notably, the third input angle may not satisfy the first angular condition of the first volume hologram to prevent both volume holograms being activated at once. Furthermore, as discussed above, the second angular condition of the second volume hologram may be satisfied by a range of angles that satisfy the Bragg condition via Bragg degeneracy. Thus, by changing the input angle of light to the volume hologram (e.g., to a fourth input angle), the position at which the second exit pupil forms may be changed.

In some embodiments, the methods and processes described herein may be tied to a computing system of one or more computing devices. In particular, such methods and processes may be implemented as a computer-application program or service, an application-programming interface (API), a library, and/or other computer-program product.

FIG. 10 schematically shows a non-limiting embodiment of a computing system 1000 that can enact one or more of the methods and processes described above. Computing system 1000 is shown in simplified form. Computing system 1000 may take the form of one or more personal computers, server computers, tablet computers, home-entertainment computers, network computing devices, gaming devices, mobile computing devices, mobile communication devices (e.g., smart phone), and/or other computing devices.

Computing system 1000 includes a logic machine 1002 and a storage machine 1004. Computing system 1000 may optionally include a display subsystem 1006, input subsystem 1008, communication subsystem 1010, and/or other components not shown in FIG. 10.

Logic machine 1002 includes one or more physical devices configured to execute instructions. For example, the logic machine may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic machine may include one or more processors configured to execute software instructions. Additionally, or alternatively, the logic machine may include one or more hardware or firmware logic machines configured to execute hardware or firmware instructions. Processors of the logic machine may be single-core or multi-core, and the instructions executed thereon may be configured for sequential, parallel, and/or distributed processing. Individual components of the logic machine optionally may be distributed among two or more separate devices, which may be remotely located and/or configured for coordinated processing. Aspects of the logic machine may be virtualized and executed by remotely accessible, networked computing devices configured in a cloud-computing configuration.

Storage machine 1004 includes one or more physical devices configured to hold instructions executable by the logic machine to implement the methods and processes described herein. When such methods and processes are implemented, the state of storage machine 1004 may be transformed—e.g., to hold different data.

Storage machine 1004 may include removable and/or built-in devices. Storage machine 1004 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage machine 1004 may include volatile, nonvolatile, dynamic, static, read/write, read-only, random-access, sequential-access, location-addressable, file-addressable, and/or content-addressable devices.

It will be appreciated that storage machine 1004 includes one or more physical devices. However, aspects of the instructions described herein alternatively may be propagated by a communication medium (e.g., an electromagnetic signal, an optical signal, etc.) that is not held by a physical device for a finite duration.

Aspects of logic machine 1002 and storage machine 1004 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 1000 implemented to perform a particular function. In some cases, a module, program, or engine may be instantiated via logic machine 1002 executing instructions held by storage machine 1004. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

It will be appreciated that a “service”, as used herein, is an application program executable across multiple user sessions. A service may be available to one or more system components, programs, and/or other services. In some implementations, a service may run on one or more server-computing devices.

When included, display subsystem 1006 may be used to present a visual representation of data held by storage machine 1004. This visual representation may take the form of a graphical user interface (GUI). As the herein described methods and processes change the data held by the storage machine, and thus transform the state of the storage machine, the state of display subsystem 1006 may likewise be transformed to visually represent changes in the underlying data. Display subsystem 1006 may include one or more display devices utilizing virtually any type of technology. Such display devices may be combined with logic machine 1002 and/or storage machine 1004 in a shared enclosure, or such display devices may be peripheral display devices.

When included, input subsystem 1008 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, communication subsystem 1010 may be configured to communicatively couple computing system 1000 with one or more other computing devices. Communication subsystem 1010 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 1000 to send and/or receive messages to and/or from other devices via a network such as the Internet.

In an example, a holographic display system comprises: a holographic optical element (HOE), including (1) a first volume hologram configured to outcouple light to form a first exit pupil upon satisfaction of a first angular condition, and (2) a second volume hologram configured to outcouple light to form a second exit pupil upon satisfaction of a second angular condition; a light source configured to introduce light into the HOE at any of a range of input angles; and a light source controller configured to control the light source to set a current input angle of the light to a first input angle that meets the first angular condition and forms the first exit pupil; the light source controller configured to change a position of the first exit pupil by controlling the light source to set the current input angle of the light from the first input angle to a second input angle, the second input angle still meeting the first angular condition of the first volume hologram; and the light source controller configured to redirect light from forming the first exit pupil to forming the second exit pupil by controlling the light source to set the current input angle of the light to a third input angle, the third input angle meeting the second angular condition of the second volume hologram and not meeting the first angular condition of the first volume hologram. In this example or any other example, the light source controller is further configured to change a position of the second exit pupil by controlling the light source to set the current input angle of the light from the third input angle to a fourth input angle, the fourth input angle still meeting the second angular condition of the second volume hologram. In this example or any other example, the first and second volume holograms are angularly multiplexed in the HOE. In this example or any other example, the first volume hologram is configured to outcouple light to form the first exit pupil at an ideal position of the first exit pupil when light from the light source is set to a current input angle that matches a recording input angle of the first volume hologram, and the second volume hologram is configured to outcouple light to form the second exit pupil at an ideal position of the second exit pupil when light from the light source is set to a current input angle that matches a recording input angle of the second volume hologram. In this example or any other example, the first angular condition is met by the recording input angle of the first volume hologram and a range of angles that satisfy a Bragg condition of the first volume hologram via Bragg degeneracy, and the second angular condition is met by the recording input angle of the second volume hologram and a range of angles that satisfy a Bragg condition of the second volume hologram via Bragg degeneracy. In this example or any other example, a spacing between the ideal position of the first exit pupil and the ideal position of the second exit pupil is less than a preset distance corresponding to an average human eye pupil diameter. In this example or any other example, the HOE further includes a plurality of additional volume holograms each configured to outcouple light to form respective exit pupils when the light source is set to respective current input angles matching respective recording input angles of the plurality of additional volume holograms, so as to form the respective exit pupils at ideal positions of the respective exit pupils. In this example or any other example, the ideal position of the first exit pupil, the ideal position of the second exit pupil, and the ideal positions of the respective exit pupils of the plurality of additional volume holograms are arrayed along a same plane perpendicular to a user eyebox plane. In this example or any other example, one or more of the ideal position of the first exit pupil, the ideal position of the second exit pupil, and the ideal positions of the respective exit pupils of the plurality of additional volume holograms are arrayed on different planes each perpendicular to a user eyebox plane. In this example or any other example, the ideal position of the first exit pupil, the ideal position of the second exit pupil, and the ideal positions of the respective exit pupils of the plurality of additional volume holograms are arrayed in the user eyebox plane as a triangular grid. In this example or any other example, the holographic display system further comprises an eye tracker configured to track a current position of a human eye pupil, and the light source controller is further configured to set the current input angle of the light to cause formation of an exit pupil proximate to the current position of the human eye pupil. In this example or any other example, the holographic display system further comprises a waveguide disposed between the light source and HOE, such that light originating from the light source propagates through the waveguide via total internal reflection before reaching the HOE. In this example or any other example, the light source includes a steerable micromirror, and the light source controller is configured to set a current angle of the steerable micromirror to set the current input angle of the light.

In an example, a method for a holographic display system comprises: via a light source, introducing light into a holographic optical element (HOE) at a first input angle that satisfies a first angular condition of a first volume hologram of the HOE, the first volume hologram configured to outcouple light to form a first exit pupil upon satisfaction of the first angular condition; changing a position of the first exit pupil by changing introduction of light into the HOE from the first input angle to a second input angle, the second input angle still meeting the first angular condition of the first volume hologram; and redirecting light from forming the first exit pupil to forming a second exit pupil by introducing light into the HOE at a third input angle that satisfies a second angular condition of a second volume hologram of the HOE and does not satisfy the first angular condition, the second volume hologram configured to outcouple light to form the second exit pupil upon satisfaction of the second angular condition. In this example or any other example, the method further comprises changing a position of the second exit pupil by changing introduction of light into the HOE from the third input angle to a fourth input angle, the fourth input angle still meeting the second angular condition of the second volume hologram. In this example or any other example, the first volume hologram is configured to outcouple light to form the first exit pupil at an ideal position of the first exit pupil when light from the light source is set to a current input angle that matches a recording input angle of the first volume hologram, and the second volume hologram is configured to outcouple light to form the second exit pupil at an ideal position of the second exit pupil when the light source is set to a current input angle that matches a recording input angle of the second volume hologram. In this example or any other example, the first angular condition is met by the recording input angle of the first volume hologram and a range of angles that satisfy a Bragg condition of the first volume hologram via Bragg degeneracy, and the second angular condition is met by the recording input angle of the second volume hologram and a range of angles that satisfy a Bragg condition of the second volume hologram via Bragg degeneracy. In this example or any other example, the HOE includes a plurality of additional volume holograms each configured to outcouple light to form respective exit pupils when the light source is set to respective current input angles matching respective recording input angles of the plurality of additional volume holograms, so as to form the respective exit pupils at ideal positions of the respective exit pupils. In this example or any other example, one or more of the ideal position of the first exit pupil, the ideal position of the second exit pupil, and the ideal positions of the respective exit pupils of the plurality of additional volume holograms are arrayed on different planes each perpendicular to a user eyebox plane.

In an example, a holographic display system comprises: a holographic optical element (HOE), including: a first volume hologram configured to outcouple light to form a first exit pupil upon satisfaction of a first angular condition, the first angular condition including input angles of light satisfying a Bragg condition of the first volume hologram, where the first volume hologram causes formation of the first exit pupil at an ideal position of the first exit pupil when a current input angle of light introduced into the HOE matches a recording input angle of the first volume hologram; and a second volume hologram angularly multiplexed with the first volume hologram in the HOE, the second volume hologram configured to outcouple light to form a second exit pupil upon satisfaction of a second angular condition, the second angular condition including input angles of light satisfying a Bragg condition of the second volume hologram, where the second volume hologram causes formation of the second exit pupil at an ideal position of the second exit pupil when the current input angle of light introduced into the HOE matches a recording input angle of the second volume hologram, and where the ideal positions of the first and second exit pupils are arrayed along different planes perpendicular to a user eyebox plane; a light source configured to introduce light into the HOE at any of a range of input angles; and a light source controller configured to control the light source to set the current input angle of the light to a first input angle that matches the recording input angle of the first volume hologram and causes formation of the first exit pupil at the ideal position of the first exit pupil; the light source controller configured to move the first exit pupil away from the ideal position by controlling the light source to change the current input angle of the light from the first input angle to a second input angle, the second input angle still satisfying the Bragg condition of the first volume hologram via Bragg degeneracy; and the light source controller configured to redirect light from forming the first exit pupil to forming the second exit pupil by controlling the light source to set the current input angle of the light to a third input angle, the third input angle meeting the second angular condition of the second volume hologram and not meeting the first angular condition of the first volume hologram.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A holographic display system, comprising:
a holographic optical element (HOE), including (1) a first volume hologram configured to outcouple light to form a first exit pupil upon satisfaction of a first angular condition, and (2) a second volume hologram configured to outcouple light to form a second exit pupil upon satisfaction of a second angular condition;
a light source configured to introduce light into the HOE at any of a range of input angles; and
a light source controller configured to control the light source to set a current input angle of the light to a first input angle that meets the first angular condition and forms the first exit pupil;
the light source controller configured to change a position of the first exit pupil by controlling the light source to set the current input angle of the light from the first input angle to a second input angle, the second input angle still meeting the first angular condition of the first volume hologram; and
the light source controller configured to redirect light from forming the first exit pupil to forming the second exit pupil by controlling the light source to set the current input angle of the light to a third input angle, the third input angle meeting the second angular condition of the second volume hologram and not meeting the first angular condition of the first volume hologram.

2. The holographic display system of claim 1, where the light source controller is further configured to change a position of the second exit pupil by controlling the light source to set the current input angle of the light from the third input angle to a fourth input angle, the fourth input angle still meeting the second angular condition of the second volume hologram.

3. The holographic display system of claim 1, where the first and second volume holograms are angularly multiplexed in the HOE.

4. The holographic display system of claim 1, where the first volume hologram is configured to outcouple light to form the first exit pupil at an ideal position of the first exit pupil when light from the light source is set to a current input angle that matches a recording input angle of the first volume hologram, and where the second volume hologram is configured to outcouple light to form the second exit pupil at an ideal position of the second exit pupil when light from the light source is set to a current input angle that matches a recording input angle of the second volume hologram.

5. The holographic display system of claim 4, where the first angular condition is met by the recording input angle of the first volume hologram and a range of angles that satisfy a Bragg condition of the first volume hologram via Bragg degeneracy, and where the second angular condition is met by the recording input angle of the second volume hologram and a range of angles that satisfy a Bragg condition of the second volume hologram via Bragg degeneracy.

6. The holographic display system of claim 4, where a spacing between the ideal position of the first exit pupil and the ideal position of the second exit pupil is less than a preset distance corresponding to an average human eye pupil diameter.

7. The holographic display system of claim 4, where the HOE further includes a plurality of additional volume holograms each configured to outcouple light to form respective exit pupils when the light source is set to respective current input angles matching respective recording input angles of the plurality of additional volume holograms, so as to form the respective exit pupils at ideal positions of the respective exit pupils.

8. The holographic display system of claim 7, where the ideal position of the first exit pupil, the ideal position of the second exit pupil, and the ideal positions of the respective exit pupils of the plurality of additional volume holograms are arrayed along a same plane perpendicular to a user eyebox plane.

9. The holographic display system of claim 7, where one or more of the ideal position of the first exit pupil, the ideal position of the second exit pupil, and the ideal positions of the respective exit pupils of the plurality of additional volume holograms are arrayed on different planes each perpendicular to a user eyebox plane.

10. The holographic display system of claim 9, where the ideal position of the first exit pupil, the ideal position of the second exit pupil, and the ideal positions of the respective exit pupils of the plurality of additional volume holograms are arrayed in the user eyebox plane as a triangular grid.

11. The holographic display system of claim 1, further comprising an eye tracker configured to track a current position of a human eye pupil, and where the light source controller is further configured to set the current input angle of the light to cause formation of an exit pupil proximate to the current position of the human eye pupil.

12. The holographic display system of claim 1, further comprising a waveguide disposed between the light source and HOE, such that light originating from the light source propagates through the waveguide via total internal reflection before reaching the HOE.

13. The holographic display system of claim 1, where the light source includes a steerable micromirror, and where the light source controller is configured to set a current angle of the steerable micromirror to set the current input angle of the light.

14. A method for a holographic display system, the method comprising:
via a light source, introducing light into a holographic optical element (HOE) at a first input angle that satisfies a first angular condition of a first volume hologram of the HOE, the first volume hologram configured to outcouple light to form a first exit pupil upon satisfaction of the first angular condition;
changing a position of the first exit pupil by changing introduction of light into the HOE from the first input angle to a second input angle, the second input angle still meeting the first angular condition of the first volume hologram; and
redirecting light from forming the first exit pupil to forming a second exit pupil by introducing light into the HOE at a third input angle that satisfies a second angular condition of a second volume hologram of the HOE and does not satisfy the first angular condition, the second volume hologram configured to outcouple light to form the second exit pupil upon satisfaction of the second angular condition.

15. The method of claim 14, further comprising changing a position of the second exit pupil by changing introduction of light into the HOE from the third input angle to a fourth input angle, the fourth input angle still meeting the second angular condition of the second volume hologram.

16. The method of claim 14, where the first volume hologram is configured to outcouple light to form the first exit pupil at an ideal position of the first exit pupil when light from the light source is set to a current input angle that matches a recording input angle of the first volume hologram, and where the second volume hologram is configured to outcouple light to form the second exit pupil at an ideal position of the second exit pupil when the light source is set to a current input angle that matches a recording input angle of the second volume hologram.

17. The method of claim 16, where the first angular condition is met by the recording input angle of the first volume hologram and a range of angles that satisfy a Bragg condition of the first volume hologram via Bragg degeneracy, and where the second angular condition is met by the recording input angle of the second volume hologram and a range of angles that satisfy a Bragg condition of the second volume hologram via Bragg degeneracy.

18. The method of claim 16, where the HOE includes a plurality of additional volume holograms each configured to outcouple light to form respective exit pupils when the light source is set to respective current input angles matching respective recording input angles of the plurality of additional volume holograms, so as to form the respective exit pupils at ideal positions of the respective exit pupils.

19. The method of claim 18, where one or more of the ideal position of the first exit pupil, the ideal position of the second exit pupil, and the ideal positions of the respective exit pupils of the plurality of additional volume holograms are arrayed on different planes each perpendicular to a user eyebox plane.

20. A holographic display system, comprising:
a holographic optical element (HOE), including:
a first volume hologram configured to outcouple light to form a first exit pupil upon satisfaction of a first angular condition, the first angular condition including input angles of light satisfying a Bragg condition of the first volume hologram, where the first volume hologram causes formation of the first exit pupil at an ideal position of the first exit pupil when a current input angle of light introduced into the HOE matches a recording input angle of the first volume hologram; and
a second volume hologram angularly multiplexed with the first volume hologram in the HOE, the second volume hologram configured to outcouple light to form a second exit pupil upon satisfaction of a second angular condition, the second angular condition including input angles of light satisfying a Bragg condition of the second volume hologram, where the second volume hologram causes formation of the second exit pupil at an ideal position of the second exit pupil when the current input angle of light introduced into the HOE matches a recording input angle of the second volume hologram, and where the ideal positions of the first and second exit pupils are arrayed along different planes perpendicular to a user eyebox plane;
a light source configured to introduce light into the HOE at any of a range of input angles; and
a light source controller configured to control the light source to set the current input angle of the light to a first input angle that matches the recording input angle of the first volume hologram and causes formation of the first exit pupil at the ideal position of the first exit pupil;
the light source controller configured to move the first exit pupil away from the ideal position by controlling the light source to change the current input angle of the light from the first input angle to a second input angle, the second input angle still satisfying the Bragg condition of the first volume hologram via Bragg degeneracy; and
the light source controller configured to redirect light from forming the first exit pupil to forming the second exit pupil by controlling the light source to set the current input angle of the light to a third input angle, the third input angle meeting the second angular condition of the second volume hologram and not meeting the first angular condition of the first volume hologram.
